(19) United States
(12) Patent Application Publication
(10) Pub. No.: US 2003/0194255 A1
(43) Pub. Date: Oct. 16, 2003

(54) Cosmetic container and applicator device

(76) Inventor: Barry Silberman, Boca Raton, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/403,534

(22) Filed: Mar. 31, 2003

Related U.S. Application Data
(60) Provisional application No. 60/369,394, filed on Apr. 2, 2002.

(51) Int. Cl. B05C 1/00; B43K 27/02

(52) U.S. Cl. 401/18; 401/17; 401/195

(57) ABSTRACT

A cosmetic applicator device is disclosed that includes a cylindrical body having a first portion and a second portion, a writing member including a tip and a writing supply incorporated in the first portion, and a reservoir for containing a cosmetic supply positioned interiorly of the second portion. The second portion is in a releasable engagement with the first portion of the cosmetic applicator.

### CROSS-REFERENCES TO RELATED APPLICATIONS

This application claims the benefit of U.S. Provisional Application Serial No. 60/369,394, filed on Apr. 2, 2002, entitled COSMETIC APPLICATOR DEVICE.

### TECHNICAL FIELD

The present invention relates generally to writing apparatuses. More specifically, the present invention relates to a combination pen and cosmetic applicator arrangement in which a cosmetic applicator is constructed from the cylindrical body of a pen and contains a reservoir to hold cosmetics.

### BACKGROUND OF THE INVENTION

Cosmetic devices of various description and use purpose are known, such devices including cosmetic elements such as lipbrushes with which a user can apply and outline lip cosmetic, and also eyeliners for use in shaping eye cosmetic. Such devices generally are provided as separate units so a user commonly has to carry each separate device in a purse, compact kit or like carrier.

The prior art includes various patented cosmetic containers, such as U.S. Pat. No. 5,257,696, which discloses a mirrored lipstick container. U.S. Pat. No. 5,178,478, discloses a lipstick case combining a holder, a lip brush, and a clip for holding a mirror and the top of a conventional lipstick. A universal dispenser cover is shown in U.S. Pat. No. 5,715,961.

The prior art also includes patents relating novelty pencils such as U.S. Pat. No. 5,647,138 for a cap sharpener for clutch-type pencils. U.S. Pat. No. 4,269,523, which discloses a pencil kit including a pencil, a coloring rod, a sheath and a cap to fit over one end that includes pencil sharpening and retaining means. Design patent D339,235, discloses a cosmetic container cap, sponge, brush and comb.

Additionally, U.S. Pat. No. 3,639,069 discloses a combined pen or pencil compartment with a differently shaped container with no lip and a lift-off top and U.S. Pat. No. 5,005,697 relates to a make-up case with a hinge.

U.S. Pat. No. 6,474,345 discloses a cosmetic container mounted on a pencil that comprises a hollow cylindrical body portion having an aperture at one end and a curved outwardly extending portion at the other end having a pivotal cap attached thereto. The outwardly extending portion comprises a recess for holding cosmetics and a notch to facilitate opening the cap that is attached by a living hinge. The hollow cylindrical body portion engages a pencil end fitting over the eraser to permit easy access to cosmetic, such as lip-gloss, for fixedly engaging the upper pencil end in a non-movable arrangement.

Accordingly, the prior art lacks a removable cosmetic container and applicator device that is used in conjunction with a writing utensil and that accommodates a variety of cosmetics.

### SUMMARY OF THE INVENTION

The present invention eliminates the above-mentioned needs for a removable cosmetic container and applicator device by providing a removable cosmetic container and applicator device that is used in conjunction with a writing utensil and allows for a variety of cosmetics to be used.

In accordance with the present invention, there is provided a cosmetic applicator device comprising a cylindrical body having a first portion and a second portion, a writing member including a tip and a writing supply incorporated in the first portion, and a reservoir for containing a cosmetic supply positioned interiorly of the second portion.

The present invention is further directed to a cosmetic applicator device comprising a cylindrical body having a first portion and a second portion, a writing member including a tip and a writing supply incorporated in the first portion, a reservoir for containing a cosmetic supply positioned interiorly of the second portion, the reservoir having an opening, and an applicator member at least partially entering the reservoir through the opening.

The present invention is still further directed to cosmetic applicator device comprising a cap member having a first portion and a second portion, the second portion having a hinge portion, a cylindrical connector for releasably and movably engaging a writing utensil, the cylindrical connector formed from the first portion, a reservoir for containing a cosmetic supply positioned interiorly of the second portion, the reservoir having an opening, and a hinged casing positionable over the opening to cover the reservoir and operatively engaged to the hinge portion.

### BRIEF DESCRIPTION OF THE FIGURES

FIG. 1 is a side view illustration of the preferred embodiment of the present invention.

FIG. 2 is another side view illustration of the preferred embodiment of FIG. 1.

FIG. 3 is a side view illustration of an alternative embodiment of the present invention of FIG. 1.

FIG. 4 is another side view illustration of the alternative embodiment of FIG. 3.

FIG. 5 is a side view of an alternative embodiment of the present invention.

FIG. 6 is an isometric view of the alternative embodiment of FIG. 5.

### DETAILED DESCRIPTION OF THE INVENTION

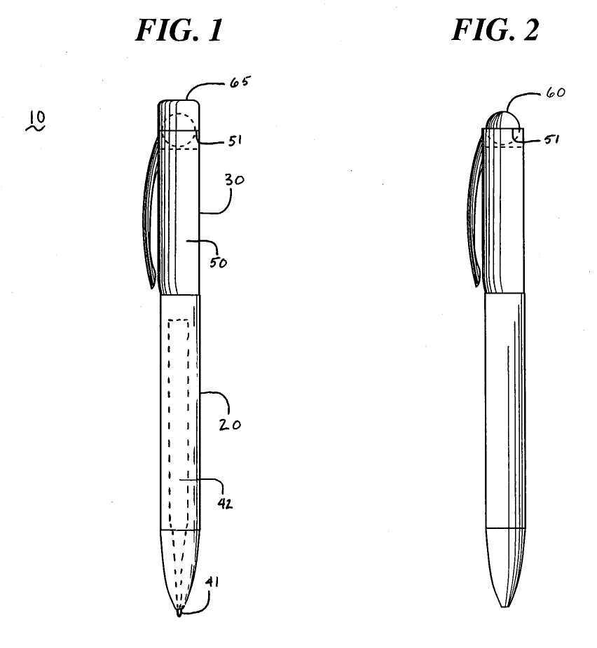

Referring now to FIG. 1, a preferred embodiment of the present invention is illustrated as cosmetic applicator 10. Cosmetic applicator 10 includes a cylindrical body having a first portion 20 and a second portion 30, a writing member 40 including a tip 41 and a writing supply 42, and a reservoir 50. Additionally, cosmetic applicator may include an opening 51 in reservoir 50 to permit access to cosmetic materials contained therein. Moreover, an applicator 60 may be used to apply the cosmetic material to a user.

First portion 20 houses writing supply 42 and terminates at tip 41. Writing supply 42 includes a writing material. The writing material can be any material used to create handwriting, including, but not limited to, carbon, graphite, various inks, dyes, and the like. Tip 41 permits the writing material to contact a writing surface, such as paper.

Reservoir 50 is formed from second portion 30 and is used to contain cosmetic materials. Second portion 30, including reservoir 50, can be removable from first portion 20 and replaced with a substitute second portion and reservoir when the cosmetic materials are depleted. The cosmetic materials include, but are not limited to, lip gloss, lip moisturizer, lip liner, eye liner, mascara, blush, base, concealing agents, and the like. In the preferred embodiment of the present invention, opening 51 permits access to the cosmetic material contained in reservoir 50.

As illustrated in FIGS. 1 and 2, access to reservoir 50 is controlled by an applicator, such as applicator 60. Applicator 60 passes at least partially through opening 51 in order to allow contact between the cosmetic material and applicator 60. Applicator 60 is then engaged to distribute the cosmetic material on to the user. This may be accomplished by inverting cosmetic applicator 10 so that the cosmetic material is in constant contact with applicator 60. As shown in FIG. 1, a cap 65 can be used to cover applicator 60 and prevent drying of the cosmetic material or inadvertent exposure of the user to the cosmetic material.

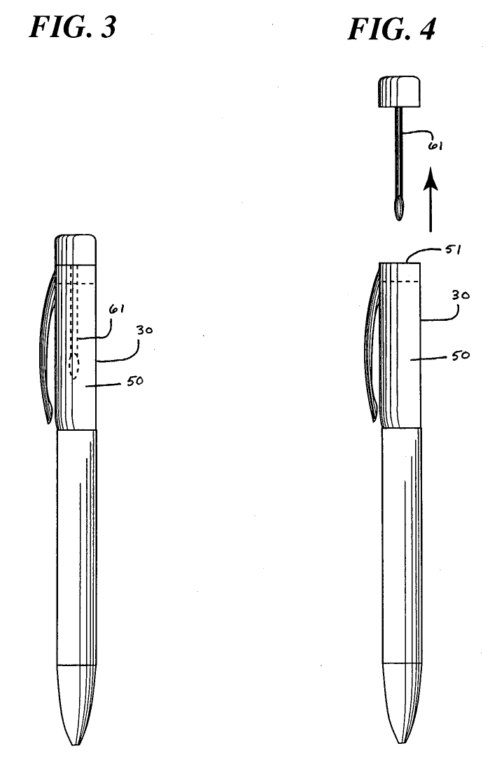

Alternatively, as illustrated in FIGS. 3 and 4, an applicator 61 is shown as being of the type commonly known in the art to apply cosmetics, such as cosmetics used for around the eyes, lips, or nails. FIG. 4 shows applicator 61 being disengaged from second portion 30. Applicator 61 additionally serves the same function of cap 65 of FIG. 1, preventing the drying of the cosmetic material or inadvertent exposure of the user to the cosmetic material.

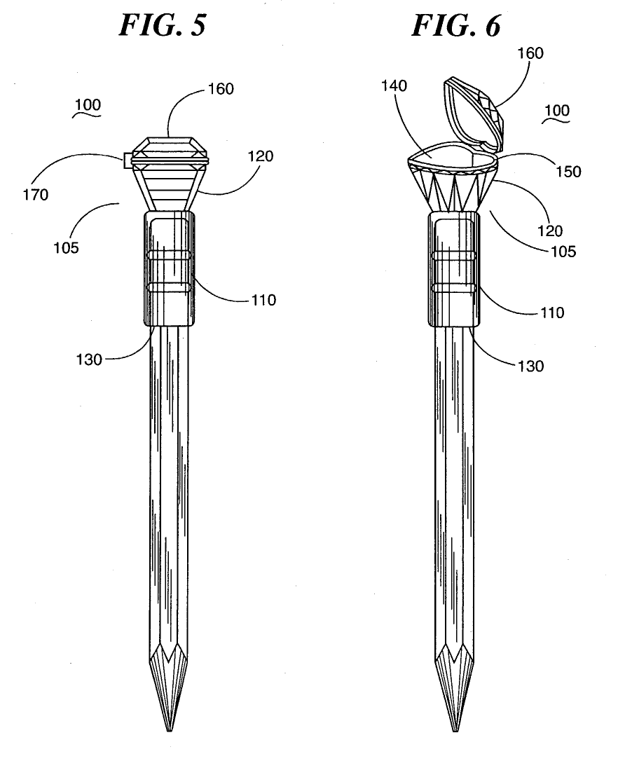

In an alternative embodiment shown in FIGS. 5 and 6, a cosmetic applicator 100 is illustrated. Cosmetic applicator 100 includes a cap member 105 having a first portion 110 and a second portion 120. First portion 110 forms a cylindrical connector 130 for frictionally engaging a writing utensil, such as a pen or pencil, in a releasable and moveable manner. The frictional engagement serves to provide a releasable connection between cosmetic applicator 100 and the writing utensil for convenient use, as well as allowing substitute applicators to replace cosmetic applicator 100 when the cosmetic supply is depleted. Second portion 120 has an interior reservoir 140 for containing a cosmetic material (not shown). As stated above, the cosmetic material includes, but is not limited to, lip gloss, lip moisturizer, lip liner, eye liner, mascara, blush, base, concealing agents, and the like. In this alternative embodiment of the present invention, opening 150, as shown in FIG. 6, permits access to the cosmetic material contained in reservoir 140.

As illustrated in FIG. 5, a hinged casing 160 having a hinge 170 can be used to cover opening 150 and prevent drying of the cosmetic material or inadvertent exposure of the user to the cosmetic material. Hinged casing 160 is positionable over opening 150 to either a closed or open position. The open position permits a user to access the cosmetic material.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. A cosmetic applicator device, comprising:
a cylindrical body having a first portion and a second portion;
a writing member including a tip and a writing supply incorporated in said first portion; and
a reservoir for containing a cosmetic supply positioned interiorly of said second portion.

2. The cosmetic applicator device according to claim 1 wherein said second portion is in a releasable engagement with said first portion.

3. The cosmetic applicator device according to claim 1 wherein said reservoir includes an opening.

4. The cosmetic applicator device according to claim 3 wherein an applicator member is operatively engaged to said second portion for accessing said reservoir through said opening.

5. The cosmetic applicator device according to claim 1 wherein a cap operatively engages said second portion.

6. A cosmetic applicator device, comprising:
a cylindrical body having a first portion and a second portion;
a writing member including a tip and a writing supply incorporated in said first portion;
a reservoir for containing a cosmetic supply positioned interiorly of said second portion, said reservoir having an opening; and
an applicator member at least partially entering said reservoir through said opening.

7. The cosmetic applicator device according to claim 6 wherein said second portion is in a releasable engagement with said first portion.

8. The cosmetic applicator device according to claim 1 wherein a cap operatively engages said second portion.

9. A cosmetic applicator device, comprising:
a cap member having a first portion and a second portion, said second portion having a hinge portion;
a cylindrical connector for releasably and movably engaging a writing utensil, said cylindrical connector formed from said first portion;
a reservoir for containing a cosmetic supply positioned interiorly of said second portion, said reservoir having an opening; and
a hinged casing positionable over said opening to cover said reservoir and operatively engaged to said hinge portion.
